(19) United States
(12) Patent Application Publication
(10) Pub. No.: US 2010/0036935 A1
(43) Pub. Date: Feb. 11, 2010

(54) METHOD FOR REACTING TO THE BROADCAST OF A FILE IN A P2P NETWORK

(75) Inventors: Bastien Casalta, Nantes (FR); Soufiane Rouibia, Nantes (FR)

Correspondence Address: OLIFF & BERRIDGE, PLC, P.O. BOX 320850, ALEXANDRIA, VA, 22320-4850, US

(73) Assignee: Trident Media Guard TMG, St. Sebastien sur Loire (FR)

(21) Appl. No.: 12/514,253

(22) PCT Filed: Nov. 22, 2007
(86) PCT No.: PCT/FR2007/052380

§ 371 Date: Aug. 10, 2009

(30) Foreign Application Priority Data
Nov. 23, 2006 (FR) 0655080

(51) Int. Cl. G06F 15/16

(52) U.S. Cl. 709/219; 709/227; 709/231; 709/223

(57) ABSTRACT

A method for establishing connections with a number of peers of a peer to peer network operating using at least one exchange protocol, such as to influence the broadcast of a file within a peer to peer network, the addresses of the number of peers being held by at least one network server. A connection is established with the network server such as to at least partially download the addresses of the number of peers connected to the network and implicated in the downloading of the file, to a control server, then connections are established between at least one control client exchanging data with the control server and peers the addresses of which have been downloaded to the control server, such as to download content from a peer to a controlled client or broadcast content from a controlled client to a peer, the downloading or broadcasting being carried out according to the exchange protocol.

The present invention relates to computer methods and systems for exerting an action on the broadcasting of information in peer-to-peer exchange systems also referred to as P2P systems.

This is concerned for example with combating the illicit broadcasting of protected works on the Internet by preventing the illegal downloading through peer-to-peer exchange systems of a file.

The file to be downloaded may for example correspond to a film in, among others, the following formats: *.arr, *.mpg, *.mov, *.esf, *.wmv, *.dvx, *.qt, *.avi. It may also concern at least one music file in, among others, the following formats: *.wav, *.mp3, *.ra, *.ram, *.aiff, *.en *.mid, or images in, among others, the following formats: *.jpg, *.bmp, *.png, *.tif, *.ps, *.eps. It may further be concerned with software packages, games or any other program protected by intellectual property rights.

A method for recovering information relating to peers exchanging protected files is known through international application WO 2006/081663. A message of the type “Attention: the downloading of this file is illegal” may then be sent to the peer whose information has been recovered.

Other methods for combating the propagation of protected files in a decentralized network are known through applications US 2002/087 885, US 2005/091 167 and US 2002/152 261.

Currently, numerous files are broadcast by means of the BitTorrent exchange system, which allows the downloading of a file fragmented into blocks from various users connected to the network, such a downloading being termed multisourcing.

In such an exchange system, it is usual to designate by client any user of the network, by peer any remote client connected to a current client and able to transmit all or part of the file sought. A source designates a peer that has downloaded the whole of the file and whose only task is to broadcast it. Peers which are not sources (leechers) are clients that wish to download the file but do not possess the whole of it. A tracker is a server which catalogs which peers are involved in the distribution of the file sought. The term free-riders designates clients seeking to receive files without sharing them.

Unlike other P2P exchange systems, in BitTorrent the clients do not form part of a global network which would comprise all the users of the exchange system but are grouped together by files. Thus, for each file distributed, the tracker manages a dynamic directory of the relevant clients.

The BitTorrent exchange system relies on exchange software executing at each client and essentially implementing two communication protocols.

The first protocol relates to the exchanges between the trackers and the clients. When a client wishes to download a file, it contacts a tracker referencing this file and receives in return a list of computer addresses informing it of other peers relevant to this same file and to which peers it can attempt to connect. At regular intervals, each client updates statistics of the tracker by communicating to it its state of downloading of the file in question and the amount of data sent (uploaded) to other clients. The data communicated to the tracker allow it to supervise the distribution of a file and, in the BitTorrent exchange system, the tracker is designed so as no longer to communicate information to a client that does not share sufficient information with the other clients.

The data exchanges between clients are performed according to a second protocol. The BitTorrent exchange system allows a client at one and the same time to download the file sought and to broadcast this same file to other clients. Each time that a client completes the downloading of a block, it announces this to the peers to which it is connected. This allows each client to know at any moment the blocks that the peers can share. For bandwidth reasons, the number of peers that a client can serve is limited.

The exchange software installed at the client is therefore designed to select the peers to be served. A selection criterion adopted in the BitTorrent exchange system consists in determining the peers at which the client downloads the most quickly so as to favor the reciprocity of the exchanges. Thus, in a periodic manner, for example every ten seconds, the exchange software evaluates which of the peers are the most efficacious for serving the client by measuring the speed at which these peers send data to it.

BitTorrent can thus be termed a selective exchange system and creates a sort of virtuous circle during the sharing of files, since he who gives only little or nothing will receive nothing.

With an aim of opening up to the other peers of the network and in the eventuality of one at least of them offering a yet higher download speed, the exchange software tests cyclically at random another peer that has not yet served the client so as to ascertain whether in response to a data send, this other peer would not send same back in its turn. When a new connection is established with a peer, the software favors the latter from among all the peers that are connected and not yet served. When the client serving the peers is a source, the exchange software no longer takes into account during the selection of the peers their upload speed, since it is then zero, but the download speed offered.

The prior art offers several conventional solutions aimed at opposing the illicit downloading of files protected by copyrights.

One of them consists in introducing files of poor quality into the network, so as to discourage cybernauts, as disclosed in applications WO 2004/107704 and US 2005/0267945. Such a solution turns out to be unsuitable when the exchange software installed at the client compares a key (hash) of the file to be downloaded with a reference key, as is the case in the BitTorrent exchange system.

The publication US 2005/0267945 describes another solution often encountered, consisting in redirecting cybernauts to resources not available on the network or to legal download sites. This solution does not prevent a peer from being served by a source once connected to the latter.

Finally, use is also sometimes made of filters capable of analyzing a request pertaining to a file to be downloaded, as in the application WO 2006/021772. The request is or is not transmitted, depending on the legal or illegal nature of the sharing of this file. Such a solution is expensive in terms of bandwidth.

The solutions of the prior art turn out to be insufficiently effective in relation to selective exchange systems such as BitTorrent or eDonkey.

The Applicant has therefore contemplated a novel method for slowing down, or indeed eliminating, the illegal propagation of protected data in a peer-to-peer network, comprising at least one peer, particularly a source, executing exchange software configured to broadcast data to at least one client according to a selective exchange protocol allowing the peer to make a selection of the clients to which data are transferred, this selection being performed as a function of one or more characteristics of the clients.

According to this novel method, false data are addressed to the peer so as to influence the selection of the clients served by the peer, in order to cause this peer to favor transfer to one or more controlled clients, the number of controlled clients being for example between 10 and 25.

The controlled clients, which seek to download the same files as the other clients of the network, particularly those most sought-after, without sharing the information received, make it possible to significantly delay the exchanges in the network, or indeed even to block it.

Such a method makes it possible to slow down the illicit broadcasting of a file since said broadcasting will take place at least partially to controlled clients.

The expression “false data” designates data not corresponding to the real state of the controlled client.

The expression “controlled client” designates a client to which the data transfer is acceptable since the latter will not retransmit said data illegally to other clients. Thus, once a controlled client has terminated the downloading of a file relating to a protected work, the content of this file can be erased.

According to an exemplary implementation of this new method, at least one controlled client connects to the tracker, for example in a periodic manner, so as to obtain an updated list of addresses of peers, particularly of sources, in the network.

The repeated connections of the controlled clients to the tracker turn out to consume a lot of bandwidth and certain trackers may be designed to react to an abnormal connection frequency by no longer transferring the updated list of addresses to the suspect client.

Moreover, certain exchange systems have restricted access and connection to the tracker requires the input of an identifier and of an IP address, and this may complicate the exchanges and slow them down.

More generally, it is of interest to be able to exert an influence on the broadcasting of a file within a peer-to-peer exchange system, whether this be to slow down the illicit broadcasting of a work or conversely to encourage that of a licit content, for example for advertising or warning purposes or for the requirements of a community of users.

There is consequently a requirement, inter alia, to further refine the novel method contemplated by the Applicant and defined above.

The subject of the invention is a method for establishing connections with a plurality of peers of a peer-to-peer network operating according to at least one exchange protocol, so as to exert an influence on the broadcasting of a file within the peer-to-peer network, the addresses of the plurality of peers connected to the network being catalogued by at least one network server, also referred to as a tracker in the case of an exchange system of the BitTorrent kind.

The peer-to-peer network can be a centralized network. The term “centralized network” designates a computer network in which the proper operation of the network is ensured by an entirely separate entity, being for example the tracker in the case of an exchange system of the BitTorrent kind.

According to an aspect of the invention, a connection is established with the network server, so as to download into a controlled server, also referred to as a controlled tracker in the case of an exchange system of the BitTorrent kind, at least partially the addresses of the plurality of peers connected to the network and pertinent to the downloading of the file, and then connections are established between at least one controlled client exchanging data with the controlled server and peers whose addresses have been downloaded into the controlled server, so as to download a content from a peer to a controlled client or broadcast a content from a controlled client to a peer, the downloading or the broadcasting being performed according to the aforesaid exchange protocol.

The expression “peer connected to the network” designates a peer connected to the network and possessing at least a part of the file sought, and the expression “network server” designates a server of the peer-to-peer network cataloguing those peers which are involved in the distribution of the file sought, such as a tracker in the case of an exchange system of BitTorrent type or such as a SuperNode in the case of an exchange system of the Gnutella 2 kind.

The term “SuperNode” designates in the case where the exchange system is of the Gnutella 2 kind the servers cataloguing in their bases the IP addresses of the peers sharing the file sought.

The expression “controlled server” designates a server contained in a computer infrastructure, to which peers of the network other than the controlled clients cannot connect unrestrictedly.

This controlled server can execute a program which is relatively close in terms of writing to that which is executed by the network server, or indeed be of the same type as the network server with a configuration suited to the controlled clients. The controlled server differs essentially from the network server only in that it is configured to communicate with the controlled clients. This sort of similarity between the programs can reduce the duration of adaptation of the program executed by the controlled server, subsequent to an upgrade of the network server program.

In an exemplary implementation of the invention, the controlled client or clients communicate with the controlled server, so as in particular to obtain the addresses of the peers, by virtue of an exclusively local computer infrastructure, particularly an internal one. The latter allows as many exchanges as necessary between the controlled clients and the controlled server with a reduced, or indeed zero, consumption of bandwidth on the P2P network. This exclusively local computer infrastructure can also comprise at least one supervision server for supervising the controlled client or clients, the role of which will be specified hereinafter.

The connection between the network server and the controlled server can be established by way of an interface system.

The expression “interface system” designates any hardware and computer means allowing the connection of the controlled server to the P2P network so as to exchange a file. This may involve any computer system, independently of its size. The file exchanged can travel through a wired, unwired or at least partially wired network.

The interface system can comprise at least one sniffer designed to connect to the network server and recover the addresses of the plurality of peers connected to the network and pertinent to the file sought, so as to transmit them to the controlled server so that the latter copies them and/or transmits them to the controlled clients concerned. The sniffer can be designed to be perceived by the network server as a client of the peer-to-peer network seeking to download a file. The term sniffer can thus designate the part of the computer infrastructure seen by the network server as a client.

The addresses of the plurality of peers connected to the network which are recovered by the controlled server, via the optional sniffer, can comprise the IP addresses and/or the ports of the currently executing applications of these peers.

The sniffer and/or the controlled server can comprise a recording means and be designed to store the addresses of the plurality of peers recovered by connecting to the network server. One at least of the sniffer or of the controlled server can be designed to compare a newly received list of addresses and the addresses previously recorded in memory and to transmit the newly obtained addresses to the controlled clients only if the latter addresses are different from those already in memory.

The sniffer and the controlled server can comprise pieces of software executing on different machines able to communicate with one another, or pieces of software executing on one and the same machine, or one piece of software executing on a single machine.

In certain exchange systems, the network server cataloguing the addresses of the plurality of the peers connected to the network can be configured to broadcast the addresses of the peers connected to the network according to a selective communication protocol, by demanding for example as a prerequisite to access to these addresses, registration of the peer wishing to recover these addresses. The sniffer can then be designed to address false information to the network server so as to download at least partially the addresses of the plurality of the peers connected to the network and which are catalogued in the network server.

The expression “false information” designates information not corresponding to the real state of the sniffer.

The sniffer can be designed to connect in a periodic manner to the network server. The higher the number of addresses of peers connected to the network, the higher may be the frequency of connection of the sniffer to the network server so as to recover as many addresses as possible of peers connected to the network despite the limitation to 50 for example in the number of randomly selected addresses of peers connected to the network which are broadcast by the network server on each connection.

The sniffer can be designed to change identifier at least once and/or IP address at least once by connecting to the network server, thereby reducing the risk of the network server blocking the requests coming from the IP address of the sniffer.

The false information transmitted by the sniffer to the network server to gain authorization to access the addresses of the peers connected to the network, can comprise a false indication relating to the number of bytes received by the sniffer and/or a false indication relating to the number of bytes sent by the sniffer.

Still in the case where the exchange system is BitTorrent, this false information can further comprise a false identifier of the sniffer. This false identifier is for example the identifier of any other client such as for example Azureus, μtorrent or BitTornado.

The controlled server can be designed to connect to at least one controlled client after at least one connection of the sniffer to the network server and to transmit at least one downloaded address to this controlled client.

In an exemplary implementation of the invention, at least one controlled client can be designed to connect to the controlled server only during a first recovery of addresses of peers connected to the network.

The controlled server can be designed to thereafter transmit addresses of peers to at least one controlled client, after verifying that these addresses have newly appeared on the network server.

This communication protocol between the controlled server and the controlled client or clients makes it possible to further reduce the requirements as regards bandwidth dedicated to the exchanges between the controlled client or clients and the controlled server since the connection is then made only on the initiative of the controlled server and only in the case of modification of the addresses of the peers connected to the network. This reduction in the necessary bandwidth makes it possible to allocate more resources of the computer infrastructure to the management of the controlled client or clients.

In an exemplary implementation of the method for slowing down, or indeed eliminating, the illegal propagation of protected data in a peer-to-peer network such as contemplated by the Applicant, at least one controlled client is designed, as soon as it has received the address of a peer able to serve it, particularly a source, to try to connect to this peer so as to download the file sought.

Preferably, each controlled client does not share any information with other peers of the network, so as to further enhance the process for combating the illicit broadcasting of a work, not only by keeping the sources occupied but by avoiding the rebroadcasting of downloaded data.

False data can be addressed to a peer, particularly to a source, directly by the controlled client or clients, particularly when combating illicit broadcasting based on the BitTorrent exchange system. The choice of the manner in which the false data reach the peer will depend on the exchange system involved.

The method according to the invention can be implemented in a selective exchange system where the characteristic or characteristics adopted for the selection of clients by a peer comprise the progress of the downloading of a file, as is the case in the BitTorrent exchange system. The exchange software executing at the peers can then be designed to favor the transfer of the data to clients whose download has progressed the furthest, the false data addressed by the controlled clients then possibly comprising a false indication on the progress of the download. The characteristic or characteristics in question can further comprise an item of information relating to the upload of the client, as is again the case for the BitTorrent exchange system. The false data can then comprise a false indication relating to the upload of the controlled client. The characteristic or characteristics concerned can also comprise the speed of downloading from the peer to the client. The characteristic or characteristics in question can furthermore comprise the number of peers with which the client is exchanging information, the amount of information already downloaded, the index numbers of the blocks constituting the downloaded information and the state of the client, that is to say whether it is a leecher or a source.

Of course, these characteristics mentioned above are not limiting and can depend on the exchange system concerned.

In an exemplary implementation of the invention, the controlled client can, after having been connected to a peer, particularly a source, be disconnected from the latter assuming that this controlled client would not be served by the peer and that the number of controlled clients served by the peer would be less than the maximum number of clients that the peer can serve. An attempt to connect to the peer of a new controlled client can follow this disconnection. The aforesaid disconnection can be ordered by a supervision server for this controlled client included in the exclusively local computer infrastructure.

The number of controlled clients connected to each peer can be counted, particularly by the supervision server, so as not to seek to connect a new controlled client to a peer when the latter is connected only to controlled clients and cannot serve more clients, having regard to the bandwidth.

According to an exemplary implementation of the invention, the controlled clients are designed to connect, from among the peers, only to the sources. This makes it possible to increase the effectiveness of the fight against the illicit broadcasting of a work in comparison to the connection to only the peers that have not terminated the download. Nevertheless, the invention does not exclude, in an implementation variant, connection to peers that are not yet sources.

In another exemplary implementation of the invention, the controlled client or clients broadcast a content to the peers of the peer-to-peer network. The controlled clients can then behave as simple sources, all proposing the same content to be downloaded, while complying with the exchange protocol. The invention makes it possible, according to this exemplary implementation, to benefit from a robust file distribution infrastructure because of the large number of sources.

The subject of the invention is farther a computer infrastructure intended to establish connections with a plurality of peers of a peer-to-peer network operating according to at least one exchange protocol, so as to exert an influence on the broadcasting of a file contained within the peer-to-peer network, the addresses of the plurality of peers connected to the network being catalogued by at least one network server.

The computer infrastructure can comprise.
at least one interface system designed to connect to the network server and recover the addresses of the plurality of peers connected to the network and catalogued by this network server,
at least one controlled server designed to download at least partially the addresses of the plurality of peers connected to the network, via the interface system, and
one or more controlled clients designed to exchange data with the controlled server and connect to the peers of the network whose addresses have been downloaded by the controlled server, so as to download a content from a peer to a controlled client or broadcast a content from a controlled client to a peer, the downloading or the broadcasting being performed according to the aforesaid exchange protocol.

At least one peer can execute exchange software configured to broadcast data to at least one client according to a selective exchange protocol allowing the peer to make a selection of the clients to which the data are transferred, this selection being performed as a function of data representative of one or more characteristics of the clients.

The computer infrastructure can comprise at least one controlled client designed to generate false data so as to influence the selection of the clients to which the data are transferred by the peer and to cause this peer to favor transfer to the controlled client or clients.

The computer infrastructure can comprise at least one terminal executing exchange software making it possible to generate these false data, The terminal can be associated with a single controlled client. Nevertheless, preferably, the computer infrastructure is designed to simulate several controlled clients.

The computer infrastructure can comprise a supervision server supervising a plurality of controlled clients, whether the latter are simulated by one and the same machine or embodied by distinct terminals.

The subject of the invention is further a supervision server designed to supervise a plurality of controlled clients. The supervision server can in particular be designed to recover information originating from the supervised controlled clients. This information can include the state of the downloading of a file.

The supervision server can be designed to order stoppage of the download and the destruction of the downloaded content when a controlled client has finished the download in question.

This supervision server can also ensure an updating of data relating to the occupancy of the peers, particularly of the sources, by the controlled clients, so as for example to indicate to the controlled clients to which peers to connect.

The invention further pertains, according to another of its aspects, to a computer program product comprising instructions readable by a computer infrastructure comprising at least one microprocessor, these instructions controlling the operation of the computer infrastructure in such a way that:
in a peer-to-peer network comprising a plurality of peers operating according to at least one exchange protocol and at least one network server cataloguing the addresses of the plurality of the peers connected to the network, the network server being configured to authorize access to these addresses according to a selective protocol, false information, particularly false identifiers and/or false IP addresses, is generated by the computer infrastructure so as to favor the broadcasting of the addresses of the peers connected to the network to the computer infrastructure.

The invention further pertains, according to another of its aspects, to a computer program product comprising instructions readable by the computer infrastructure comprising at least one microprocessor, these instructions controlling the operation of the computer infrastructure, in such a way that:
in a peer-to-peer network comprising a plurality of peers operating according to at least one exchange protocol and a network server cataloguing the plurality of peers, a connection is established by the computer infrastructure with this network server so as to download into the computer infrastructure at least partially the addresses of the plurality of peers connected to the network and pertinent to the downloading of a file, and then connections are established between the computer infrastructure and peers whose addresses have been downloaded into the computer infrastructure so as to download a content from a peer to the computer infrastructure or broadcast a content from the computer infrastructure to a peer, the downloading or the broadcasting being performed according to the aforesaid exchange protocol.

Each computer program product can be recorded and/or downloaded on any suitable medium, for example optical, magnetic disk, electronic memory or magnetic tape.

The subject of the invention is further a controlled server as such, a sniffer as such, as well as a controlled client as such.

The invention may be better understood on reading the detailed description which will follow of nonlimiting examples of implementation of the latter, and on examining the appended drawing, in which:

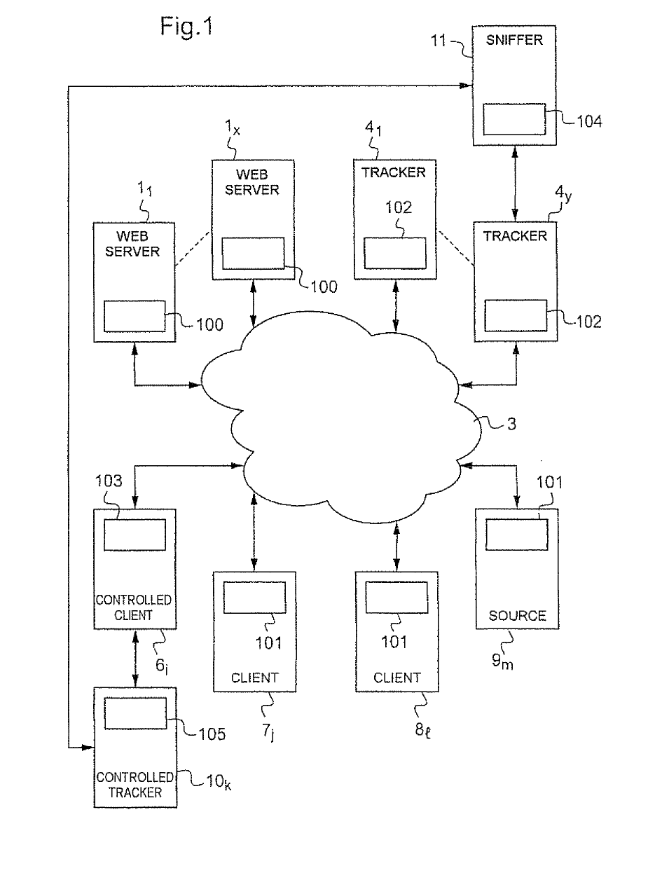

FIG. 1 represents in block diagram form a computer network implementing a selective exchange system such as BitTorrent,

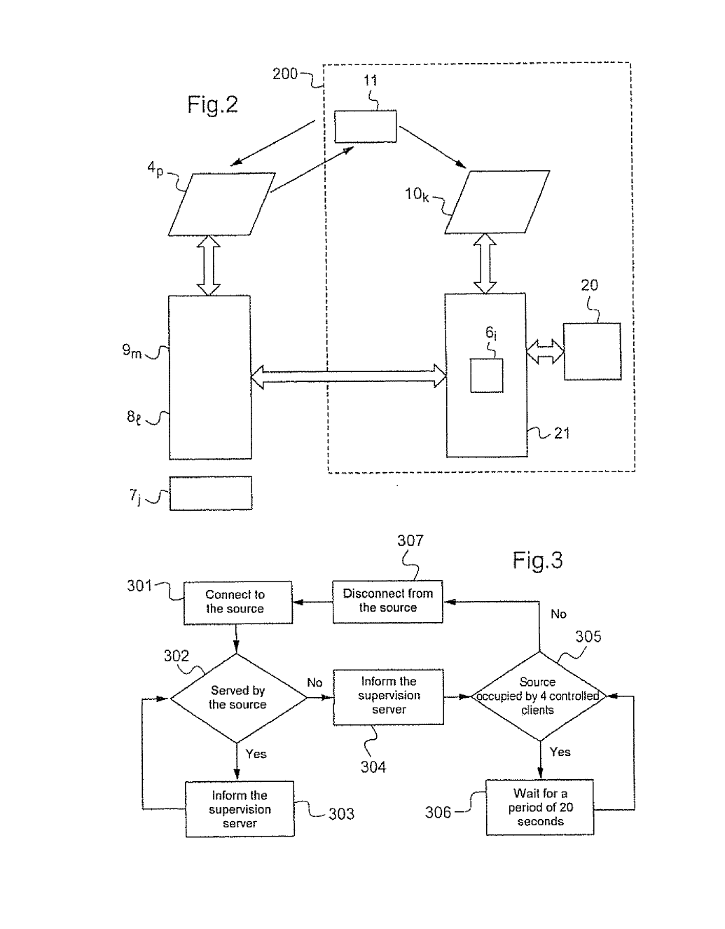

FIG. 2 represents in a schematic and partial manner an exemplary computer architecture for the implementation of the method according to the invention, and

FIGS. 3, 4 and 5 illustrate steps in the implementation of the method according to the invention.

The description which follows assumes that the exchange system is BitTorrent and that the network is the Internet. Of course, this is only an example and the invention can apply to other exchange systems and to other networks. The network can thus be, for example, a local network such as Ethernet or a university campus network. It can also involve networks using wireless technologies such as telephone networks.

FIG. 1 represents a computer network 3 allowing exchanges, in this instance the Internet, to which are connected Web servers 1₁ to 1ₓ, network servers 4₁ to 4ⱼ, also called trackers in the case of an exchange system of the BitTorrent kind, clients 7ⱼ not serving any peer (free-riders), clients 8₁ sharing data (leechers) and clients 9ₘ which are sources (seeders).

The clients 7ⱼ, 8₁ and 9ₘ can be personal computers or other types of computer terminals, for example personal digital assistants, smartphones or more powerful machines.

In the BitTorrent exchange system, the Web servers 1₁ to 1ₓ contain general information 100 which identifies the file or files that can be downloaded, by describing attributes of the latter, for example the name, the size, the number of blocks, if any, and gives the address of the tracker or trackers 4₁ to 4_{y} which supervise the distribution of a given file.

Each client 7ⱼ to 9ₘ executes a client version of a piece of exchange software 101 such as for example Bitcomet, Azureus, BitTorrent official client, Burst, G3torrent, ABC, etc., making it possible to connect to the trackers 4₁ and 4_{y} and to share data with other clients relevant to the same file.

The trackers 4₁ to 4_{y} execute a tracker version of the exchange software 102.

A sniffer, whose function will be specified further on, executing modified exchange software 104 is connected to one at least of these trackers 4ₚ.

In accordance with the invention, at least one controlled client 6ᵢ is connected to the network 3.

This controlled client executes a modified client version 103 of the exchange software used by the other clients, this version making it possible inter alia to exchange with peers other than other controlled clients and to connect to a controlled tracker 10ₖ.

The controlled tracker 10ₖ is connected, by a connection which is not represented, to the sniffer 11.

The controlled tracker 10ₖ executes software 105 that is as close as possible to the tracker version of the exchange software 102.

The request format used by the software 105 of the controlled tracker can be the same as that used by the exchange software 102. The software 105 executed by the controlled tracker differs from the exchange software 102 as regards the number of IP addresses sent from the controlled tracker to the controlled clients and as regards the protocol according to which these addresses are sent.

The software 105 executed by the controlled tracker can be designed to send the IP addresses in packets of 50 for example and to save the index of the last IP address sent. The software 105 is further designed to respond to the next request of a controlled client on the basis of the index of the following IP address.

The software 105 makes it possible to avoid the repeated sending of the IP addresses to the controlled clients 6ᵢ and to economize on bandwidth. Once the entirety of the IP addresses has been sent to the controlled client, the software 105 can be designed to connect to a controlled client only in the case of newly received addresses of peers connected to the network.

FIG. 2 represents an exemplary computer infrastructure 200 allowing the implementation of the invention.

The computer infrastructure 200 can be local and comprise a supervision server 20, the sniffer 11, the controlled clients 6 and the controlled tracker 10ₖ mentioned above, The sniffer 11 can be designed to connect to a network tracker 4ₚ and to transmit information recovered during this connection to the controlled tracker 10ₖ, itself designed to exchange information with the controlled clients 6ᵢ. The latter communicate with the peers 9ₘ.

The supervision server 20 has the job of supervising several controlled clients 6₁, 6₂ to 6ₙ, possibly being greater than or equal to 10 for example. These controlled clients 6ᵢ can be simulated by one and the same computer system 21 or as a variant, can be associated respectively with distinct terminals. If appropriate, the supervision server 20 can be integrated into the computer system 21.

The computer infrastructure 200 is designed to perform first of all a search for the peers connected to the network 3. Once these peers have been identified, the controlled clients 6ᵢ connect to these peers so as to keep them as occupied as possible. In the example illustrated, the controlled clients 6₁ to 6ₙ are connected to diverse peers 8₁, 9ₘ of the network 3. A controlled client 6ᵢ can connect for example up to more than 1000 peers at a time.

The search for the addresses of the peers connected to the network is performed by the sniffer 11 which connects to the tracker 4ₚ as a client and recovers all the information relating to the addresses of the peers connected to the network and present in this tracker 4ₚ, for example the IP addresses and the ports of the applications executed by the peers connected to the network.

The sniffer 11 then transmits the recovered addresses to the controlled tracker 10ₖ which can then store them in a memory, which may be electronic or comprise an optical or magnetic medium on which the information is recorded.

If no source address is present in the list of addresses sent by the tracker 4ₚ, the sniffer 11 reconnects to the tracker 4ₚ to ask for a new list of addresses.

During the first recovery of addresses of peers connected to the network, the controlled clients 6ᵢ can connect to the controlled tracker 10ₖ.

Then, after each recovery of addresses of peers connected to the network by the sniffer 11 and each transmission of these addresses to the controlled tracker 10ₖ, the list of the newly received addresses can be compared with that of the stored addresses and, in the case of a difference, the controlled tracker can transmit these new addresses to the controlled clients 6ᵢ.

The recovery of the addresses can thus be performed by the sniffer 11 and not by the entirety of the controlled clients 6ᵢ. In the case of a tracker 4ₚ demanding the registration of an identifier and an IP address of a client prior to any access to the base of addresses of the peers connected to the network, only the address of the sniffer 11 can be communicated to the tracker 4 and not that of each controlled client, which would constitute an expensive task in terms of time and resources.

The controlled clients 6ᵢ can be relieved of the job of having to search for the addresses of the peers, which task is centralized and performed by the sniffer 11.

The controlled clients 6ᵢ, having recovered the addresses of the peers connected to the network, can then connect to the latter so as to prevent the illegal propagation of protected data to other peers of the network wishing to download them.

When the transfer by the source 9ₘ to a client 8₁ of data is completed, the exchange software 101 executed by this client 8₁ alerts the other peers in touch with this client 8₁ that this block is available at the latter.

If all the data are available on the network elsewhere than at the source 9ₘ, the latter can disconnect.

The controlled clients 6ᵢ are not designed to communicate, in the example considered, with the free-riders 7ⱼ.

FIG. 3 is a flowchart illustrating certain tasks performed by a controlled client 6ᵢ.

The objective of any controlled client 6ᵢ may be to be served for as long as possible by any peer, particularly any source 9ₘ, to which it is connected.

The controlled client 6ᵢ can therefore first of all connect during a step 301 to a peer, particularly a source 9ₘ, with whose particulars it has been provided by the controlled tracker 10ₖ.

During the following step 302, if the client 6ᵢ is served by the source 9ₘ, it informs the supervision server 20 of this in step 303 and then performs step 302 again.

When the client 6ᵢ is not served by the source 9ₘ, it informs the supervision server 20 of this in the course of a step 304. The supervision server 20 determines during a step 305 whether the source 9ₘ is already occupied by other controlled clients 6ᵢ.

In a current version of BitTorent, a source can serve four different clients. If these clients are already controlled clients, the controlled client 6ᵢ is placed on standby in a step 306 for a certain time span, for example of the order of 20 seconds, before performing step 305 again. When the source 9ₘ does not serve controlled clients alone, the controlled client 6ᵢ disconnects in the course of a step 307 from the source 9ₘ and recommences step 301 while profiting from a characteristic of the BitTorent exchange system consisting in favoring, during the choice by a source 9ₘ of the clients to be served, those which connected most recently.

The controlled clients can transmit to the source 9ₘ false indications relating to their download speed, indicating for example a greater speed than that of the other clients in the network.

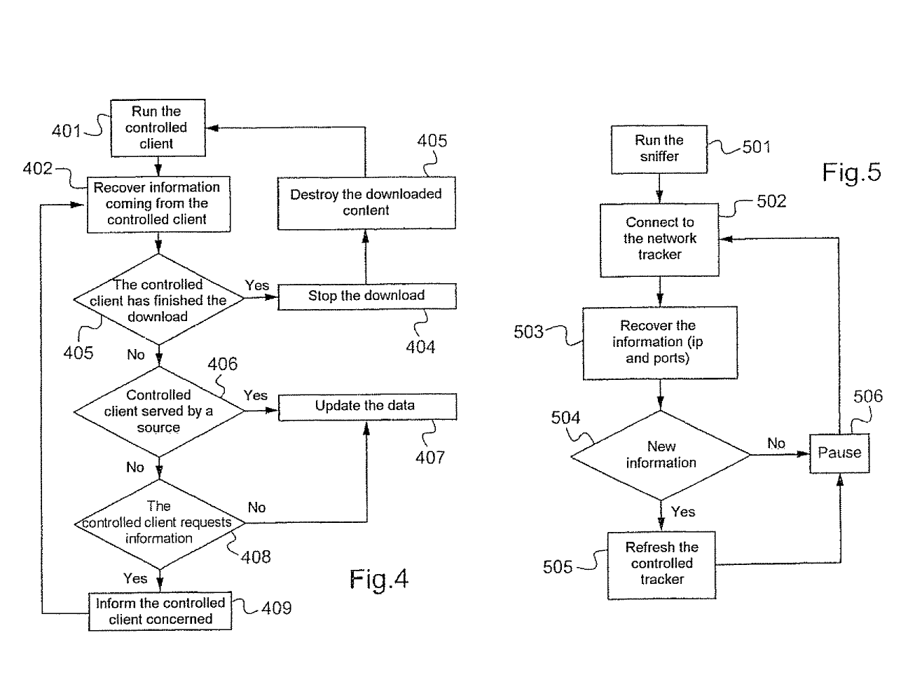

FIG. 4 is a flowchart illustrating certain tasks performed by the supervision server 20.

The supervision server 20 is designed to catalog the number of peers, particularly of sources, to which each controlled client 6ᵢ is connected and supervises the progress of the downloading of the file. Once a controlled client 6ᵢ has terminated the downloading of the content, the supervision server 20 brings about the erasure of the content downloaded by this controlled client 6ᵢ.

During a first step 401, the particulars of a peer, especially of a source 9_{g}, are communicated to a controlled client 6ᵢ on standby waiting to connect.

During a following step 402, the supervision server 20 recovers information sent to it by this controlled client 6ᵢ and which allows it for example to update the list and/or the number of controlled clients served by a peer, especially a source 9ₘ.

In step 403, the supervision server 20 evaluates whether the controlled client 6ᵢ has terminated the download. If such is the case, the download is stopped in step 404, and its content is thereafter destroyed in step 405, then the supervision server recommences step 401.

When the download is not finished, the supervision server 20 evaluates in the course of step 406 whether the controlled client 6ᵢ is still served by the source 9ₘ. If such is still the case, the supervision server 20 updates the occupancy state of the peers, particularly of the sources.

When the controlled client 6ᵢ is no longer served by the source 9ₘ, it can, in the course of a step 408, request information from the supervision server 20 relating for example to the number of controlled clients currently connected to this source. The supervision server 20 then provides the requested information to the controlled client 6ᵢ before recommencing step 402.

If the controlled client 6ᵢ has not requested any information, the supervision server 20 performs the step 407 of updating the data, for example the occupancy state of the peers, particularly of the sources.

FIG. 5 is a flowchart illustrating certain cyclic tasks performed by the sniffer 11.

During a first step 501, a dynamic IP address of the sniffer 11 is generated. In the case of a tracker 4ₚ demanding registration prior to any connection, a step 500 of registering the IP address of the sniffer 11, not represented, takes place before step 501. The sniffer 11 connects to the tracker 4ₚ in the course of a step 502 and behaves like any peer of the network by sending a request to the supervision tracker 4ₚ.

In order to gain authorization to access the addresses of the peers connected to the network, the request addressed by the sniffer 11 comprises a false number of bytes received, a false number of bytes sent, an identifier and an IP address that are generated randomly on each connection as well as an item of information relating to the desired file. This request, addressed in a periodic manner, allows the sniffer 11 not to be banished by the tracker 4ₚ.

In the course of a step 503, the sniffer 11 downloads from the tracker 4ₚ the addresses of the peers connected to the network and which contain the IP addresses and the ports of the applications executed by the peers connected to the network.

In step 504, the sniffer 11 compares the new addresses with those in memory, particularly those obtained subsequent to the request issued in step 502 of the previous cycle, and in case of modification, the sniffer 11 transmits this information to the controlled tracker 10ₖ in the course of a step 505.

In the course of the following step 506, corresponding to the standby time before addressing a new request, the sniffer 11 modifies its identifier and its IP address.

If in step 504 the addresses of the peers connected to the network which are recovered by the sniffer 11 are the same as those already in memory, we go directly to step 506.

In the case of unprotected data whose broadcasting is legal, the controlled clients 6ᵢ constitute peers, particularly sources, and thus favor the propagation of the data.

The invention is not limited to the BitTorent exchange system and also applies to other exchange systems of the same type, such as Gnutella 2.

The invention can be implemented jointly with other measures intended to combat the illicit broadcasting of protected works.

The expression “comprising a” must be understood as being synonymous with “comprising at least one” unless the converse is specified.

1. A method for establishing connections with a plurality of peers of a peer-to-peer network operating according to at least one exchange protocol, so as to exert an influence on the broadcasting of a file within the peer-to-peer network, the addresses of the plurality of peers being catalogued by at least one network server, in which method a connection is established with this network server so as to download into a controlled server at least partially the addresses of the plurality of peers connected to the network and pertinent to the downloading of the file, and then connections are established between at least one controlled client exchanging data with the controlled server and peers whose addresses have been downloaded into the controlled server, so as to download a content from a peer to a controlled client or broadcast a content from a controlled client to a peer, the downloading or the broadcasting being performed according to the aforesaid exchange protocol.

2. The method as claimed in claim 1, wherein the controlled client or clients communicate with the controlled server so as to obtain the addresses of the peers through an exclusively local computer infrastructure.

3. The method as claimed in claim 1, the peer-to-peer network comprising at least one peer executing exchange software configured to broadcast data to at least one client according to a selective exchange protocol allowing the peer to make a selection of the clients to which data are transferred, this selection being performed as a function of one or more characteristics of the clients.

4. The method as claimed in claim 1, wherein the controlled client or clients download content from the peers of the peer-to-peer network.

5. The method as claimed in claim 1, wherein the controlled client or clients broadcast a content to the peers of the peer-to-peer network.

6. The method as claimed in claim 1, the peer-to-peer network being of BitTorrent type.

7. The method as claimed in claim 1, the connection between the network server and the controlled server being established by way of an interface system comprising at least one sniffer, configured to connect to the network server while being seen by the latter as a client and to transmit to the controlled server addresses recovered during this connection.

8. The method as claimed in claim 7, the sniffer being configured to connect in a periodic manner to the network server.

9. The method as claimed in claim 7, wherein the sniffer addresses false information to the network server so as to gain authorization to access the addresses.

10. The method as claimed in claim 9, the sniffer being configured to change identifier and/or IP address at least once by connecting to the network server.

11. The method as claimed in claim 7, the sniffer being configured to transmit the recovered addresses to the controlled server only if they differ from those previously transmitted.

12. The method as claimed in claim 7, the controlled server being configured to transmit to at least one controlled client, after at least one connection of the sniffer to the network server the addresses of the peers.

13. The method as claimed in claim 7, the controlled server being configured to transmit to at least one controlled client any address originating from the network server and different from those previously transmitted to this controlled client.

14. The method as claimed in claim 1, the controlled client or clients being configured to communicate with a supervision server.

15. A computer infrastructure for establishing connections with a plurality of peers of a peer-to-peer network operating according to at least one exchange protocol, so as to exert an influence on the broadcasting of a file contained within the peer-to-peer network, the addresses of the plurality of peers connected to the network being catalogued by a network server, the computer infrastructure comprising:
at least one interface system configured to connect to the network server and recover the addresses of the plurality of peers catalogued by this network server,
a controlled server configured to download at least partially via the interface system the addresses of the plurality of peers and
one or more controlled clients configured to exchange data with the controlled server and connect to the peers of the network whose addresses have been downloaded by the controlled server, so as to download a content from a peer to a controlled client or broadcast a content from a controlled client to a peer, the downloading or the broadcasting being performed according to the exchange protocol.

16. A computer program product comprising instructions readable by a computer infrastructure comprising at least one microprocessor, these instructions controlling the operation of the computer infrastructure in such a way that:
in a peer-to-peer network comprising a plurality of peers operating according to at least one exchange protocol and a network server cataloguing the plurality of the peers connected to the network and configured to authorize access to these addresses according to a selective protocol,
false information, is generated by the computer infrastructure so as to favor the broadcasting of the addresses of the peers connected to the network to the computer infrastructure.

17. A computer program product comprising instructions readable by a computer infrastructure comprising at least one microprocessor, these instructions controlling the operation of the computer infrastructure, in such a way that:
in a peer-to-peer network comprising a plurality of peers operating according to at least one exchange protocol and a network server cataloguing the plurality of peers, a connection is established by the computer infrastructure with this network server so as to download into the computer infrastructure at least partially the addresses of the plurality of peers connected to the network and pertinent to the downloading of a file, and then connections are established between the computer infrastructure and peers whose addresses have been downloaded into the computer infrastructure, so as to download a content from a peer to the computer infrastructure or broadcast a content from the computer infrastructure to a peer, the downloading or the broadcasting being performed according to the aforesaid exchange protocol.

18. The method as claimed in claim 9, wherein the false information comprises a false indication relating to the number of bytes received and/or sent by the sniffer and/or a file requested by the sniffer.

19. The computer program product as claimed in claim 16, wherein the false information comprises false IP addresses and/or false identifiers.
